(19) United States
(12) Patent Application Publication
(10) Pub. No.: US 2004/0251133 A1
(43) Pub. Date: Dec. 16, 2004

(54) Voltammetric ion-selective biosensor

(76) Inventors: Timothy James Wooster, Clayton (AU); Michael John Honeychurch, Clayton (AU); Alan Maxwell Bond, Clayton (AU)

Correspondence Address: QUARLES & BRADY LLP, 411 E. WISCONSIN AVENUE, SUITE 2040, MILWAUKEE, WI, 53202-4497, US

(21) Appl. No.: 10/485,535

(22) PCT Filed: Aug. 2, 2002
(86) PCT No.: PCT/GB02/03569

(30) Foreign Application Priority Data
Aug. 2, 2001 (GB) 0118931.5

(51) Int. Cl. G01N 27/403

(52) U.S. Cl. 204/405

(57) ABSTRACT

A method for the quantitative determination of an ion in a fluid is described which comprises subjecting the fluid to voltammetry using an electrode which comprises an electrically conducting support possessing a coating of a solid capable of selecting ions when electrochemically induced during operation.

This invention relates to the quantitative and selective measurement of ionic materials in fluids.

The most common method of quantitative and selective detection of ions has been by using ion-selective electrodes. These electrodes selectively measure the ionic concentration of a fluid by comparison against a calibrant fluid by ion transfer at a membrane positioned in front of the measuring electrode. In devices that have self-contained calibration fluids built in at the time of manufacture, there is frequently a need for low temperature storage to maintain the calibration fluid in a state suitable for use over a reasonable shelf life. Clearly this is a disadvantage of such systems. It would be much better to have an electrode that can be produced ready for use, which requires no pre-calibration or any special storage conditions. The present invention enables one to have a much simpler and more robust ion sensor which is therefore easier and faster to use than traditional membrane ion-selective electrodes while possessing a longer shelf life.

The present invention is based on the concept of selectively measuring ions in fluids by voltammetry using “solid state” electrodes. According to the present invention there is provided a method for the quantitative determination of an ion in a fluid which comprises subjecting the fluid to voltammetry using an electrode which comprises an electrically conducting support possessing a coating of a solid capable of selecting, generally by ion inclusion/exclusion or intercalation of ions when electrochemically induced during operation. By using such solids, cations such as ammonium, included substituted ammonium such as alkyl ammonium, typically of 1 to 6 carbon atoms such as tetramethyl-, tetraethyl- and tetrapropyl-ammonium, sodium, potassium, magnesium, calcium, rubidium, copper and iron together with inorganic anions such as nitrate, nitrite and chloride and organic anions which can be aliphatic or aromatic such as acetate, ascorbate and phenolate can be measured quantitatively using an appropriate process which is capable of “trapping” these ions. Generally this is achieved by ion inclusion/exclusion or intercalation. Effectively, the solid will possess a lattice which is sufficiently open to allow ingress/egress of such ions in order to achieve charge neutralisation. The following description will therefore be directed at such solids which will be referred to as intercalating solids but it is to be appreciated that solids which can select ions in other ways are not excluded. Thus any solid which is capable of undergoing ion ingress/egress processes upon being induced electrochemically during operation can be used for the electrode surface. The preferred process should have high (chemical) reversibility i.e. the solid undergoes a (chemically) reversible ingress/egress of ions when electrochemically induced. By “chemical reversible” we mean that ions can move both in and out as distinct from “electrochemically reversible” i.e. electron transfer. The preferred process should also possess a selectivity (preferably large) for one ion (the target analyte ion) over all others.

Suitable solids which can be employed in the present invention are electroactive, generally redox active, and include either the donor or acceptor component of a charge transfer salt pair. They are generally compounds sometimes referred to as synmetals. Preferably the solids are semi-conductors. In particular, donor solids containing various cyano carbons in which a substantial portion of the functionality consists of cyano groups are suitable for detecting cations. As a consequence of the large number of cyano groups, the cyano carbons are highly reactive electrophilic molecules. Specific examples which may be used in the present invention include tetracyanoethylenes, tetracyanoquinodimethanes (TCNQ), N,N′-dicyano-p-quinodiimine (DCNQI) and N,7,7-tricyanoquinomethanimines. The analogues (any quinone) and the many derivatives of these can also be used including halogenated eg. fluorinated derivatives such as tetracyanotetrafluoroquinodimethane, and allylated e.g. methylated derivatives such as tetracyanoquinoethylene (TCNE) and 2,4,6,8-tetracyanoazulene as well as analogues including other quinoid compounds such as 2,3-dichloro-5,6-dibenzo-1,4-quinone. The reduced forms of the above compounds generally intercalate cations but it will be appreciated that other intercalators are capable of “trapping” anions including chloride, nitrate and bromide. Acceptors which can achieve anion trapping include tetrathiafulvalene (TTF), tetrathiafulvalene analogues and derivatives thereof including alkylated derivatives, for example, methyl substituted derivatives such as tetramethyltetrathiafulvalene (TMTTF), as well as ethylene and methylene derivatives such as bis(ethylenedithio) tetrathiafulvalene (ET) and bis-(methylenedithio) tetrathiafulvalene (BMDT-TTF), including the corresponding selenium or other hetero atom compounds. Other solids which can be used include the fullerene family including C₆₀, C₇₀, C₇₆ and C₈₄ fullerenes. Other compounds which can be used include phthalocyanines such as platinum phthalocyanine and certain tellerium derivatives such as:

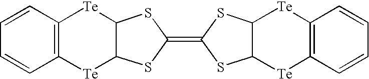

Further details can be found in, for example, J.Am.Chem.Soc. 93, 2258 (1971), 97, 2291 (1975) and 98, 1596 (1976), Synth. Met. 114,209 (2000) and Chem. Mater. 6 1378 (1994) and the like. Typically, the solids take the form of a microcrystalline coating but other forms including amorphous material is not excluded.

The precise nature of the base electrode is largely unimportant. It will generally be made of metal or carbon and includes, for example, printed conductive electrodes formed by the incorporation of conductive media within a polymeric coating or ink. Suitable metals which can be used include silver, gold, platinum, copper and nickel as well as other metals that provide conductivity in the final electrode. Alternatively, conductive carbons can be particularly effective. These can either be in a particulate form or in a graphitic form that typically possesses an aspect ratio. The electrode is preferably a microelectrode.

In a preferred embodiment of the present invention a layer of membrane, typically ion exchange membrane, is applied over the intercalating solid. The presence of the membrane slows down or prevents any dissolution of the charged form from the surface of the electrode. It may also help to prevent extraneous solid matter in the sample reaching the intercalating solid. The ion exchange membrane should be capable of exchanging ions of the same charge as those capable of being intercalated by the intercalating solid. Thus when the solid is a cyano carbon, the membrane should be a cation exchange resin. On the other hand, if the synmetal is TTF then an anion exchange resin is employed. Conventional ion exchange resins can be used for this purpose and, in particular, perfluorinated cation exchange resins such as that sold under the trade mark Nafion by Aldrich as well as an anion exchange resin prepared from polyvinylchloride and anion resin powder (see J Membr. Sci. 187, 39 (2001)), Neosepta A M, and polyether sulphone resins.

It can be desirable to immobilise an ionophore such as a crown ether onto/into the membrane to impede the passage of ions other than those which it is desired to measure.

In operation, a working electrode is used in conjunction with a counter electrode and/or a reference electrode. Accordingly the present invention also provides a device for the quantitative determination of an ion in a fluid which comprises a receptacle for said fluid, the receptacle comprising an electrode as defined above, a counter electrode for supplying a potential difference, and a reference electrode. In a particularly preferred embodiment, all three electrodes can be formed on a single sensor using, for example, a carbon ink to provide three conductive tracks on the electrode. On one of these tracks which forms the working electrode the layer of intercalating solid is deposited. A second track acts as the counter electrode to which a potential difference is applied while the third track forms a reference electrode which provides a potential reference. Typically, the reference electrode bears a silver/silver chloride coating. In the case of microelectrodes it is possible for the reference and counter electrodes to be combined, thus forming a two electrode device. The present invention also provides a device which comprises two or more of the electrodes.

It will be appreciated that the present invention enables one to have pre-prepared electrodes which are ready for analysis in a solid state thereby providing an instant test without the need for running pre-calibration tests and without concern for the stability and condition of the calibration fluid. Thus the electrodes can be made disposable. Alternatively, they can be made re-useable because after use it is a simple matter to remove the previous test solution memory by voltammetric cycling. Typically, 10 cycles are sufficient for this purpose. It has been found that electrodes which have subjected to over 400 cycles suffer minimal performance loss. In one preferred embodiment the electrode(s) is/are provided on a test strip.

The deposition of the intercalating solid on the electrode can be accomplished by a variety of processes including mechanical abrasion and pressing, including screen printing, vapour deposition, but, preferably, from a solution of the intercalating solid which is then dried. Thus a solution of the intercalating solid can first be prepared in an inert organic solvent. The solvent can be polar or non-polar; low boiling solvents are preferred to minimise any change to the intercalating solid. Suitable solvents include dichloromethane, acetonitrile and acetone. A wide range of concentrations have been found to be effective, for example from 0.1 to 50 mg per ml. The actual volume of solution deposited on the electrode depends on the surface area of the electrode but, typically, 0.5 ml to 2 ml can be applied to 100 mm² of electrode surface area. Typically there will be a deposit of 10 to 50 μg although these amounts can, and should, be reduced significantly when detecting low ions concentration such as less than 10 μM M⁺ for TCNQ and less than 25 mM X⁻ for TTF.

Likewise the ion exchange resin can typically be applied over the coating of intercalating solid from a solution or dispersion of the membrane material. For example a perfluorinated ion exchange resin can be applied as a dispersion in an aqueous alcoholic solution. It is also possible to use a prefabricated porous membrane which can be attached by, for example, mechanical fastening or welding or by using an adhesive.

In order to determine the ionic concentration and ionic species present in a fluid, the voltammetric peak position (and/or mid point position) and voltammetric peak separation (resulting, for example, from a critical nucleation over potential), respectively, are measured using, for example, linear scan voltammetry or potential step chronoamperometry at the electrodes. Desirably the fluid should have a roughly neutral pH, e.g. from 6.5 to 7.5, to avoid the possibility of interference by H⁺or OH⁻ions. The voltammetric peak positions are associated with oxidation and reduction with the average of the two corresponding to the reversible response. Either the oxidation, reduction or reversible mid point potentials may be used as the detector response. Preferably, the measurements are carried out using a purpose designed potentiostat that operates at scan rates typically from 10 to 500 mV/s.

Typical equipment which can be used for this purpose includes BioAnalytical Systems electrochemical analysers 100A and 100B, a Radiometer Voltalab 40 and an Eco Chemie Autolab PGSTAT100.

The redox transformation for the cation sensing solid (e.g. TCNQ) occurs according to (but not restricted to) the following equation, using TCNQ as an example:

x TCNQ_{(solid)}+ne⁻+nM⁺_{(aq)}⇄(M⁺)ₙ(TCNQ)ₙ(TCNQ)_{x-n(solid)}

For small cations e.g. Na⁺, K⁺ and Rb⁺, n=1 while for larger group I cations other stoichiometries may be observed e.g. Cs⁺, x=3 and n=2.

The redox transformation for the anion sensing solid (e.g. TTF) occurs according to (but not restricted to) the following equation:

xTTF_{(solid)}+nX⁻_{(aq)}→(TTF⁺)ₙ(X⁻)ₙ(TTF)_{(x-n)(solid)}+ne⁻

In the case of TTF approximately three quarters of the solid is oxidized resulting in a mixed valence product, thus for the halides x=1 and n=0.71-0.76.

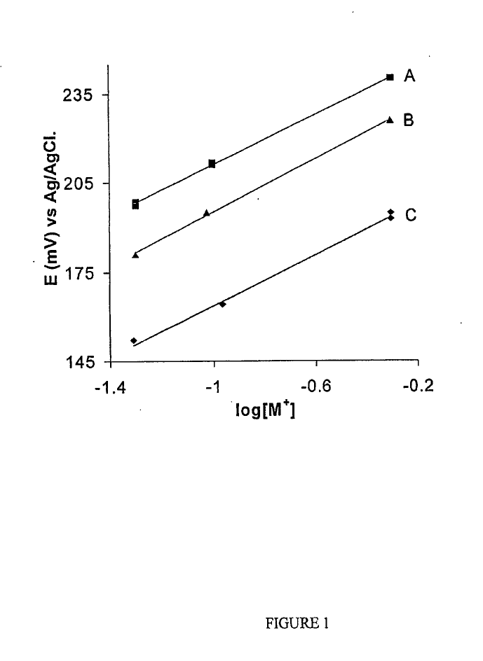

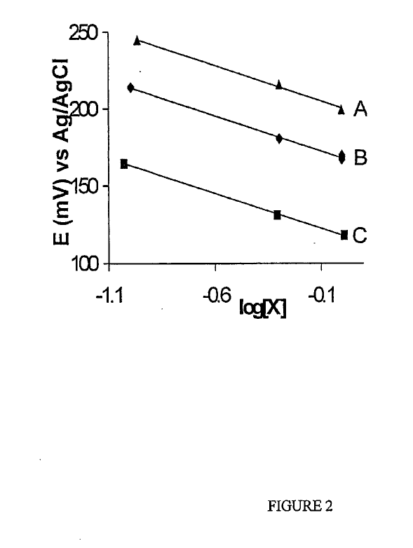

In either case a change in analyte concentration will cause the reversible potential (E_{R}) to change by S per concentration decade (i.e. a change in the concentration by a factor of 10 will result in a change of S in the reversible potential) change of analyte for cation sensing solids (see e.g. FIG. 1—discussed below) and anion sensing solids (see e.g. FIG. 2). For typical synmetals this can be expressed as:

E_{R}=E^{o′}−S log [ionic analyte concentration]

where E^{o′} is a constant for a particular process and E_{R} is the reversible potential at an [ionic analyte concentration].

Therefore a calibration plot for the response of the intercalation solid may be empirically determined. For example, by measuring the reversible potential for two given concentrations, S may be determined, allowing concentrations to be determined from a measurement of the reversible potential.

Different analyte ions induce different electrochemical responses (e.g. reversible potential) from the intercalation solids. By characterising the response of different analytes to each intercalation solid an analyte fingerprint can be obtained.

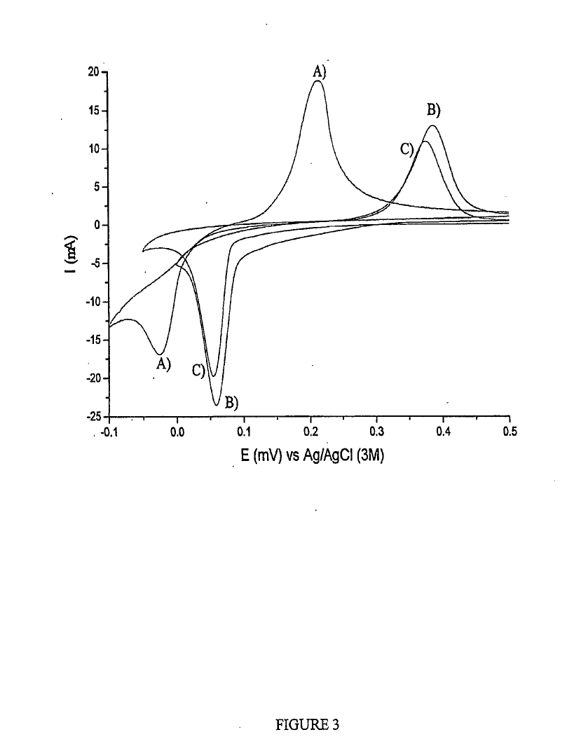

Results obtained using different intercalation solids indicate that the intercalation solids prefer some ions over others, that is they are ion selective (e.g. FIG. 3). When presented with solutions of mixed ions the intercalation solid exhibits a selectivity trend towards these ions. This trend is:

cation sensing intercalation solids (e.g. TCNQ) prefer ions whose mid point potentials are more positive;

anion sensing intercalation solids (e.g. TTF) prefer ions whose mid point potentials are more negative.

Accordingly when the fluid contains more than one anion or cation, the solid is preferably one which provides the more or most positive mid point potential for the cation to be determined in a mixture of cations or the more or most negative mid point potential for the anion to be determined in a mixture of anions.

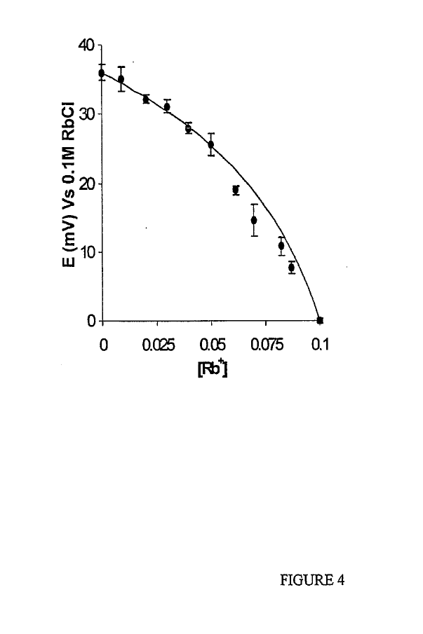

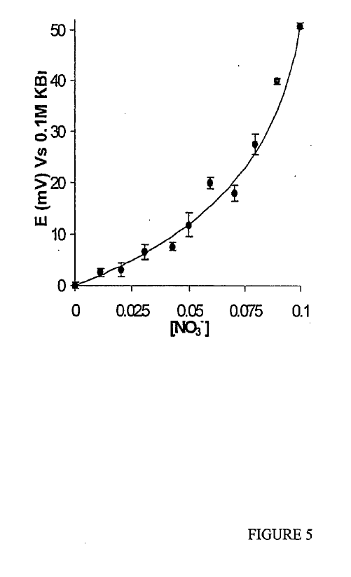

The mid point potential of the intercalation solid, when presented with multi-ion solutions, obeys a relationship of blends described by (but not restricted to) the Nicolsky ion selective electrode equation (e.g. FIG. 4 for an cation sensing solid and FIG. 5 for a anion sensing solid).

E_{R}=x+S log([A⁺]+K_{A}⁺_{B}⁺[B⁺])

where [A⁺] is the main ion concentration and [B⁺] is the interferent ion concentration.

The constants x and S correspond to the intersection and slope of the calibration equation for the main ion (A⁺) respectively. K_{A,}⁺_{B}⁺ is the selectivity ratio of the electrode for the interfering ion (B⁺). These selectivity ratios may be empirically determined by many methods such as the “separate solution method”.

Before taking a reading it is generally desirable to carry out some pre-cycling which tends to give rise to the lowest energy state which corresponds to the steady state. During pre-cycling, a form of Ostwald ripening (or other process) tends to cause a change in structure, for example increase the crystal size, of the intercalating solid.

It can therefore be seen that the present invention provides a ready means for the quantitative determination of ions in a particular fluid provided adequate sensitivity is achieved. In general the concentration of an ion can be determined in single cation or single anion analyte solutions. However, it can also be possible to determine the concentration from a multi cation or multi anion solution, for example if the concentrations of the different ions are very different from one another (thus low concentrations of other ions may not cause a response in the electrode) or if the affinity of the ions to intercalate is very different. Thus kinetic as well as thermodynamic selectivity across the solid can be used to determine the concentration of an ion in the presence of another; a quick scan can be made to determine the concentration of one ion in the presence of another which has much slower kinetics or different thermodynamics for the ion including/excluding solid. For example in blood sodium cation levels are typically about 150 mM while potassium cation levels are 4-5 mM. Thus there should be no interference from the potassium in a sodium concentration determination. If desired a flow injection setup (FIA) which has an ion chromatograph column built in that presents single ion bands to the electrode, can be used for multi ion detection.

It will be appreciated that multielectrodes can be devised with different intercalators which respond to different ions forming different electrodes; a pH electrode can also be included. These different electrodes. can be presented on a single test strip.

The following Examples further illustrate the present invention.

### EXAMPLE 1

Carbon printed electrodes utilising a carbon ink Electrodag 423ss (Acheson Colloids Company) printed onto a 300 micron PET film formed the sensor. The sensor design consists of three conductive tracks that are parallel lines formed by printing the conductive ink onto the PET film. After printing, the ink was dried at a temperature of 90° C. for ninety minutes.

The three conductive tracks represent:

1. a working electrode, on which the intercalating solid is deposited along with a coating of ion exchange membrane

2. a counter electrode which applies a potential, and

3. a reference electrode which provides a potential reference. The reference electrode has a further coating of a silver/silver chloride ink.

### EXAMPLE 2

0.5 ml of a 2.5 mM acetone solution of TCNQ was micropipetted onto the surface of a polished (1 micron alumina) glassy carbon electrode®=2.5 mm) and allowed to dry in air for 15 minutes. 2×0.5 ml of a Nafion solution (prepared by tenfold dilution (50:50 ethanol:water) of a 5% mass solution of Nafion suspended in lower aliphatic alcohol) was then pipetted onto the prepared surface and allowed to dry in air for 1 hour.

The prepared electrode was then pre-conditioned by immersion in 0.1M KBr and cycled between 500 and −100 mV vs Ag/AgCl with an initial negative sweep direction for 20 cycles at a scan rate of 50 mVs⁻¹. The electrode was then immersed in sample solution.

### EXAMPLE 3

0.5 ml of a 2.5 mM acetone solution of TTF was micropipetted onto the surface of a polished (1 micron alumina) platinum electrode r=0.5 mm) and allowed to dry in air for 15 minutes. The prepared electrode was then pre-conditioned by immersion in 0.1M KNO₃ and cycled between −100 and 300 mV vs Ag/AgCl with an initial positive sweep direction for 20 cycles at a scan rate of 50 mVs⁻¹. The electrode was then immersed in sample solution.

### EXAMPLE 4

The electrode system of Example 2 was used to determine reversible potential versus log [M⁺] for TCNQ for various concentrations of A) NaCl, B) KCl and C) RbCl. Voltammograms (v=100 mVs⁻¹) were obtained with reversible potential data recorded from the 10th cycle. The results obtained are shown in FIG. 1.

### EXAMPLE 5

The electrode system of Example 3 was used to determine reversible potential versus log [X⁻] for TTF for various concentrations of A) K⁺Cl⁻_{(aq)}, B) K⁺NO₃⁻_{(aq)} and C) K⁺Br⁻_{(aq)}. Voltammograms (v=100 mVs⁻¹) were obtained with reversible potential data recorded from the 10th cycle. The results obtained are shown in FIG. 2.

### EXAMPLE 6

Reversible potentials (normalised with respect to TCNQ reversible potential when immersed in 1M rubidium chloride (Rb Cl_{(aq)})) were obtained for a TCNQ modified glassy electrode (a=7.21 mm, v 25 mVs⁻¹) immersed in a mixed ion solution containing KCl_{(aq)} and RbCl_{(aq)}. ([K⁺_{(aq)}]≅0.1 −[Rb⁺_{(aq)}]) was obtained experimentally. The results obtained are shown in FIG. 4 (open circle n=4) together with those predicted by the Nicolsky equation (solid line). Clearly a good correspondence exists.

### EXAMPLE 7

Reversible potentials (normalised with respect to TTF reversible potential when immersed in 1 M KNO_{3(aq)}) were obtained for a TCNQ modified platinum electrode (a=0.784 mm, v 100 mVs⁻¹) immersed in a mixed ion solution containing KBr_{(aq)} and KNO_{3(aq)}. ([Br⁻_{(aq)}]M≅0.11 M−[NO₃⁻_{(aq)}]M) was obtained experimentally. The results obtained are shown in FIG. 5 (open circle n=4) together with those predicted by the Nicolsky equation (solid line). Clearly a good correspondence exists.

### EXAMPLE 8

Cyclic voltammograms were obtained at a scan rate of 100 mV of TCNQ immobilised (by powder abrasion) on a glassy carbon electrode and immersed in, 0.1 M aqueous solutions of A), ammonium nitrate, B) tetraethylammonium bromide and C) a 50:50 mixture of ammonium nitrate and tetraethyl ammonium bromide. The results are shown in FIG. 3.

It will be noted that the voltamagram for tetraethyl ammonium bromide is hardly affected by the presence of ammonium nitrate. This clearly shows, therefore, that TCNQ has a preference for the tetraethyl ammonium ion over the ammonium ion. The more positive mid point potential is then provided by the tetraethyl ammonium ion.

1. A method for the quantitative determination of an ion in a fluid which comprises subjecting the fluid to voltammetry using an electrode which comprises an electrically conducting support possessing a coating of a solid capable of selecting ions when electrochemically induced during operation.

2. A method according to claim 1 wherein the solid is a redox active material.

3. A method according to claim 1 wherein the solid undergoes a reversible ingress/egress of ions when electrochemically induced.

4. A method according to claim 3 wherein the solid undergoes a selective reversible ingress/egress of ions when electrochemically induced.

5. A method according to claim 4 wherein the solid is a synmetal.

6. A method according to claim 1 wherein the solid is either the donor or acceptor of a charge transfer salt pair.

7. A method according to claim 6 wherein the solid is tetracyanoquinodimethane or tetrathiafulvalene or an analogue or derivative thereof.

8. A method according to claim 1 wherein the support is formed of a metal or carbon.

9. A method according to claim 1 wherein the solid coating has an ion exchange membrane over it, the membrane being capable of exchanging ions of the same charge as those capable of being intercalated by the solid.

10. A method according to claim 1 wherein the fluid contains more than one anion or cation and the solid is one which provides the more or most positive mid point potential for the cation to be determined in a mixture of cations or the more or most negative mid point potential for the anion to be determined in a mixture of anions.

11. A method according to claim 1 wherein the fluid is placed in a cell comprising the electrode, a counter electrode for supplying a potential differences, and a reference electrode.

12. A method according to claim 11 wherein the cell forms a microelectrode.

13. A method according to claim 1 wherein the electrode is reset following a determination by voltammetric cycling.

14. (Cancelled)

15. A device for the quantitative determination of an ion in a fluid by subjecting the fluid to voltammetry, the device comprising an electrode having an electrically conducting support that possesses a coating of a solid capable of selecting ions when electrochemically induced during operation of the device.

16. A device for the quantitative determination of an ion in a fluid which device comprises a receptacle for said fluid, the receptacle comprising an electrode that possesses a coating of a solid capable of selecting ions when electrochemically induced during operation of the device, and a counter electrode for supplying a potential difference.

17. A device according to claim 31 wherein the electrode, the counter electrode and the reference electrode comprise three conductive tracks on a single support.

18. A device according to claim 16 wherein the counter electrode comprises an electrically conducting support possessing a coating of a solid capable of selecting ions when electrochemically induced during operation.

19. A support comprising at least two conductive tracks, one track forming an electrode having a coating of a solid capable of selecting ions when electrochemically induced during operation and another track forming a counter electrode for supplying a potential difference, and the support further comprising a reference electrode.

20. A support according to claim 19 comprising a reference electrode as a third track.

21. An electrode which comprises an electrically conducting support possessing a coating of a solid capable of intercalation of ions when electrochemically induced during operation, said solid not being tetracyanoquinodimethane or tetrathiafulvalene.

22. (Canceled)

23. A method according to claim 15 wherein the solid is a redox active material.

24. A device according to claim 15 wherein the solid undergoes a reversible ingress/egress of ions when electrochemically induced.

25. A device according to claim 15 wherein the solid undergoes a selective reversible ingress/egress of ions when electrochemically induced.

26. A device according to claim 15 wherein the solid is a synmetal.

27. A device according to claim 15 wherein the solid is either the donor or acceptor of a charge transfer salt pair.

28. A device according to claim 27 wherein the solid is tetracyanoquinodimethane or tetrathiafulvalene or an analogue or derivative thereof.

29. A device according to claim 15 wherein the support is formed of a metal or carbon.

30. A device according to claim 15 wherein the coating has an ion exchange membrane over it, the membrane being capable of exchanging ions of the same charge as those capable of being intercalated by the solid.

31. A device according to claim 16 further comprising a reference electrode.
